(19) United States
(12) Patent Application Publication
(10) Pub. No.: US 2026/0032080 A1
(43) Pub. Date: Jan. 29, 2026

(54) ENHANCED ROUTING PERFORMANCE

(71) Applicant: MELLANOX TECHNOLOGIES, LTD., Yokneam (IL)

(72) Inventors: Eran Gil Beracha, Tel Aviv (IL); Yam Zvi Gellis, Tel Aviv (IL)

(21) Appl. No.: 18/782,396

(22) Filed: Jul. 24, 2024

(51) Int. Cl. H04L 45/00; H04L 45/24; H04L 45/74

(52) U.S. Cl. CPC H04L 45/566; H04L 45/24; H04L 45/742

(57) ABSTRACT

Embodiments of the present disclosure are directed to network devices utilizing routing engines of different types. One routing engine or set of routing engines can use, for example, adaptive routing which, while computationally heavy, more accurately routes packets and therefore provides a more efficient use of available bandwidth. The other routing engine or set of routing engines can utilize, for example, random routing which is much less computationally heavy. Packets can be routed by selectively utilizing one of these engines based on the size of the packet or the type of packet. For example, large packets such as Maximum Transfer Unit (MTU) packets can be routed using the adaptive routing engine and small packets such as an ACKnowledge (ACK) packet can be routed using the random routing engine.

### FIELD OF THE DISCLOSURE

The present disclosure is generally directed to network devices and more particularly to network devices utilizing routing engines of different types.

### BACKGROUND

Adaptive routing, sometimes also referred to as dynamic routing, is a process in which a router, switch, or similar device can forward data via a different route for a given destination based on the current conditions of a communication network. While effective, adaptive routing requires a significant amount of computational overhead to implement. Accordingly, replicating multiple adaptive routing engines within a device is costly while limiting the number of routing engine in a device limits the available bandwidth of that switch.

### BRIEF SUMMARY

Embodiments of the present disclosure are directed to network devices utilizing routing engines of different types. One routing engine or set of routing engines can use, for example, adaptive routing which, while computationally heavy, more accurately routes packets and therefore provides a more efficient use of available bandwidth. The other routing engine or set of routing engines can utilize, for example, random routing which is much less computationally heavy. Packets can be routed by selectively utilizing one of these engines based on the size of the packet or the type of packet. For example, large packets such as Maximum Transfer Unit (MTU) packets can be routed using the adaptive routing engine and small packets such as an ACKnowledge (ACK) packet can be routed using the random routing engine.

According to one embodiment, a communication device can comprise a communication interface, a cache coupled with the communication interface, a first routing engine coupled with the cache, and a second routing engine coupled with the cache. The first routing engine and the second routing engine can perform routing of packets from the cache through the communication interface using different types of routing. A control circuit controlling operation of the communication device can causes the communication device to read a packet from the cache and identify a packet type for the packet. In response to the identified packet type being a first packet type, the control circuit can cause the communication device to provide the packet to the first routing engine. In response to the identified packet type being a second packet type, the control circuit can cause the communication device to provide the packet to the second routing engine.

According to one aspect, identifying the packet type for the packet can be based on header information for the packet.

According to one aspect, identifying the packet type for the packet can be based on a predefined packet length.

According to one aspect, identifying the packet type for the packet can be based on an opcode for the packet.

According to one aspect, the first packet type can be identified in response to the packet being a Maximum Transmission Unit (MTU) packet.

According to one aspect, the second packet type can be identified in response to the packet being an ACKnowledgement (ACK) packet.

According to one aspect, the first routing engine can comprise an adaptive routing engine.

According to one aspect, the second routing engine can comprise a random routing engine.

According to one aspect, the second routing engine can comprise a hash-based routing engine.

According to one aspect, the second routing engine can comprise a weighted Equal-Cost Multi-Patch routing engine.

According to one aspect, the second routing engine can comprise a round robin routing engine.

According to another embodiment, a system can comprise a communication network and a communication device coupled with the communication network. The communication device can comprise a communication interface coupled with the communication network, a cache coupled with the communication interface, a first routing engine coupled with the cache, and a second routing engine coupled with the cache. The first routing engine and the second routing engine can perform routing of packets from the cache through the communication interface using different types of routing. A control circuit can control operation of the communication device and can cause the communication device to read a packet from the cache and identify a packet type for the packet. In response to the identified packet type being a first packet type, the control circuit can cause the communication device to provide the packet to the first routing engine. In response to the identified packet type being a second packet type, the control circuit can cause the communication device to provide the packet to the second routing engine.

According to one aspect, identifying the packet type for the packet can be based on an opcode in header information for the packet.

According to one aspect, the first packet type can be identified in response to the packet being a Maximum Transmission Unit (MTU) packet.

According to one aspect, the second packet type can be identified in response to the packet being an ACKnowledgement (ACK) packet.

According to one aspect, the first routing engine can comprise an adaptive routing engine.

According to one aspect, the second routing engine can comprise a random routing engine.

According to yet another embodiment, a method for routing packets in a communication device can comprise reading a packet received from a communication network and identifying a packet type for the packet. In response to the identified packet type being a first packet type, the packet can be provided to a first routing engine. In response to the identified packet type being a second packet type, the packet can be provided to a second routing engine of the communication switch. The first routing engine and the second routing engine can perform routing of packets from a cache through a communication interface using different types of routing.

According to one aspect, the first packet type can be identified in response to the packet being a Maximum Transmission Unit (MTU) packet, and the second packet type can be identified in response to the packet being an ACKnowledgement (ACK) packet.

According to one aspect, the first routing engine can comprise an adaptive routing engine and the second routing engine can comprise a random routing engine.

### BRIEF DESCRIPTION OF THE SEVERAL VIEWS OF THE DRAWINGS

The present disclosure is described in conjunction with the appended figures, which are not necessarily drawn to scale.

FIG. 1 is a block diagram illustrating an exemplary environment in which embodiments of the present disclosure may be implemented.

FIG. 2 is a block diagram illustrating additional details of an exemplary network device according to one embodiment of the present disclosure.

FIG. 3 is a flowchart illustrating an exemplary process for routing packets according to one embodiment of the present disclosure.

FIG. 4 is a flowchart illustrating an exemplary process for routing packets according to another embodiment of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the described embodiments. It is understood that various changes may be made in the function and arrangement of elements without departing from the spirit and scope of the appended claims.

It will be appreciated from the following description, and for reasons of computational efficiency, that the components of the system can be arranged at any appropriate location within a distributed network of components without impacting the operation of the system.

Furthermore, it should be appreciated that the various links connecting the elements can be wired, traces, or wireless links, or any appropriate combination thereof, or any other appropriate known or later developed element(s) that is capable of supplying and/or communicating data to and from the connected elements. Transmission media used as links, for example, can be any appropriate carrier for electrical signals, including coaxial cables, copper wire and fiber optics, electrical traces on a printed circuit board (PCB), or the like.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “automatic” and variations thereof, as used herein, refers to any appropriate process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not to be deemed “material.”

The terms “determine,” “calculate,” and “compute,” and variations thereof, as used herein, are used interchangeably, and include any appropriate type of methodology, process, operation, or technique.

Various aspects of the present disclosure will be described herein with reference to drawings that are schematic illustrations of idealized configurations.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and this disclosure.

As used herein, the singular forms “a,” “an,” and “the” are intended to include the plural forms as well, unless the context clearly indicates otherwise. It will be further understood that the terms “comprise,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. The term “and/or” includes any and all combinations of one or more of the associated listed items.

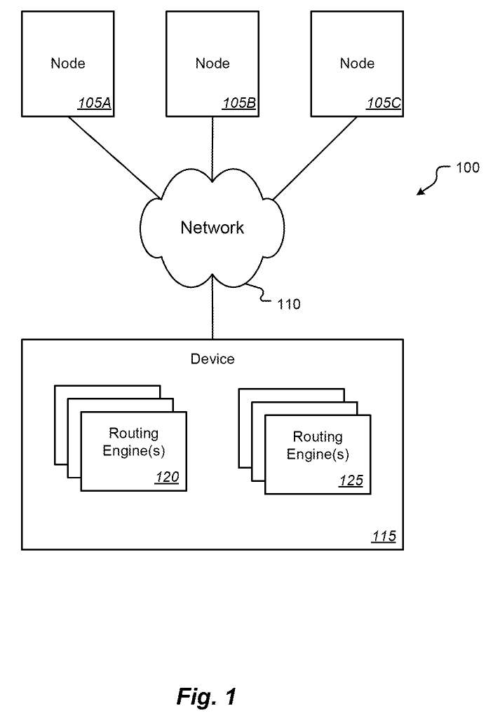

Referring now to FIGS. 1-4, various systems and methods for routing of data packets in communications networks will be described. Embodiments described herein are directed to routers, switches, and/or other network devices utilizing routing engines of different types. One routing engine or set of routing engines can use, for example, adaptive routing which, while computationally heavy, more accurately routes packets and therefore provides a more efficient use of available bandwidth. The other routing engine or set of routing engines can utilize, for example, random routing which is much less computationally heavy. Packets can be routed by selectively utilizing one of these engines based on the size of the packet or the type of packet. For example, large packets such as Maximum Transfer Unit (MTU) packets can be routed using the adaptive routing engine and small packets such as an ACKnowledge (ACK) packet can be routed using the random routing engine.

FIG. 1 is a block diagram illustrating an exemplary environment in which embodiments of the present disclosure may be implemented. As illustrated in this example, the environment can comprise any number of nodes 105A-105C coupled with a communication network 110. Each node 105A-105C can comprise, for example, a server or other computing device as known in the art. The communication network 110 can comprise any number of wired and/or wireless, local-area and/or wide-area networks as known in the art.

Also coupled with the communication network 110 can be a network device 115. Generally speaking, the network device 115 can receive data packets transmitted from the nodes 105A-105C and route the data packets to an intended destination over the communication network 110. To do so, the device 115 can utilize a number of routing engines 120 and 125. The routing engines 120 and 125 can perform routing of data packets in various ways including, but not limited to, adaptive routing, random spraying, etc. Since each method of routing has different capabilities, the hardware to support it is different. If a routing method has many features and requires a big database it may be costly to duplicate it many times, whereas a simple routing method that doesn’t have many features and has a smaller database is much cheaper to duplicate many times over.

According to one embodiment, the routing engines 120 and 125 can comprise a set of one or more routing engines 120 utilizing one type of routing and a set of one or more routing engines 125 utilizing a different type of routing. For example, a first set of one or more routing engines 120 can utilize adaptive routing while a second set of one or more routing engines 125 can utilize random routing. Considering the size and complexity of an adaptive routing engine, the first set of one or more routing engines 120 can comprise relatively few routing engines compared to the second set of one or more routing engines 125 utilizing random routing or a similar, less complex routing technique.

If there are relatively fewer adaptive routing engines 120 in a given switch, the number of packets that can be processed within them per second is smaller than can be handled by the random of other routing engines 125. Therefore, if all packets are being procced in the adaptive routing engines 120, the number of packets that the device 115 can route per second is limited by this first set of routing engines 120. However, by utilizing the relatively greater number of other routing engines 125, some routing can be offloaded from the first set of routing engines 120 resulting in a higher number of packets being procced per second.

According to embodiments of the present disclosure, packets can be routed using the different routing engine 120 and 125 based on various factors such as packet size and/or packet type, for example. For example, the data packets can be considered to consists of two size of packets, big packets such as Maximum Transfer Unit (MTU) and small packets such as ACKnowledge (ACK) packets. If the number of MTU packets is roughly two or three times the number of ACK packets and the bandwidth used for MTU packets is roughly 100-1000 times bigger than the bandwidth used for ACK packets, if the less sophisticated routing method is used for the smaller ACK packets, roughly one third of the packets will be affected but only a fraction of the bandwidth. The performance of random versus adaptive routing in terms of bandwidth and latency is comparable, with adaptive routing have the edge, therefore we can assume not a lot of bandwidth and latency degradation. The result is that the device 115 can now route a higher number of packets per second.

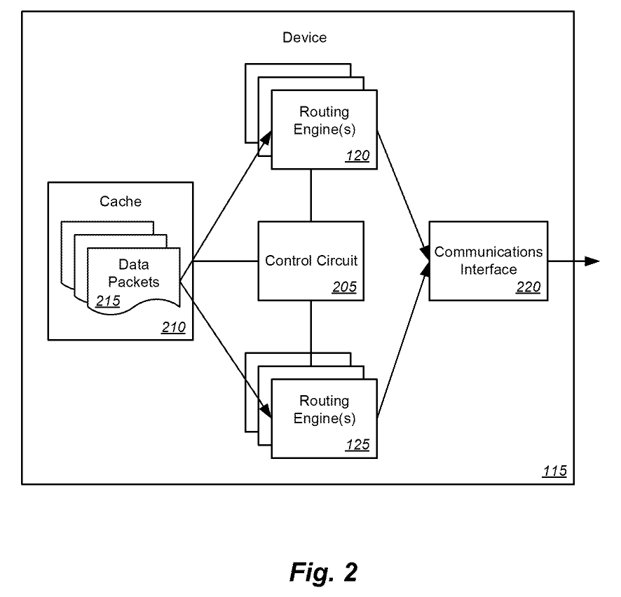

FIG. 2 is a block diagram illustrating additional details of an exemplary network device according to one embodiment of the present disclosure. As illustrated in this example, a communication device 115 can comprise a communication interface 220, a cache 210, a first set of one or more routing engines 120 coupled with the cache 210, and a second set of one or more routing engines 125 coupled with the cache 210. The first set of one or more routing engines 120 and the second set of one or more routing engines 125 can perform routing of packets 215 from the cache 210 through the communication interface 220 using different types of routing. For example, the first set of one or more routing engines 120 can comprise adaptive routing engines and the second set of one or more routing engines 125 can comprise random routing engines, hash-based routing engines, weighted Equal-Cost Multi-Patch routing engines, round robin routing engine, and or others.

A control circuit 205 controlling operation of the communication device 115 can causes the communication device 115 to read a packet 215 from the cache 210 and identify a packet type for the packet 215. For example, identifying the packet type for the packet can be based on header information for the packet, a size of the packet and a predefined packet length, an opcode for the packet, etc. According to one embodiment, the first packet type can be identified in response to the packet being a Maximum Transmission Unit (MTU) packet and the second packet type can be identified in response to the packet being an ACKnowledgement (ACK) packet.

In response to the identified packet type being a first packet type, the control circuit 205 can cause the communication device 115 to provide the packet 215 to the first set of one or more routing engines 120. In response to the identified packet type being a second packet type, the control circuit 205 can cause the communication device 115 to provide the packet 215 to the second set of one or more routing engines 125.

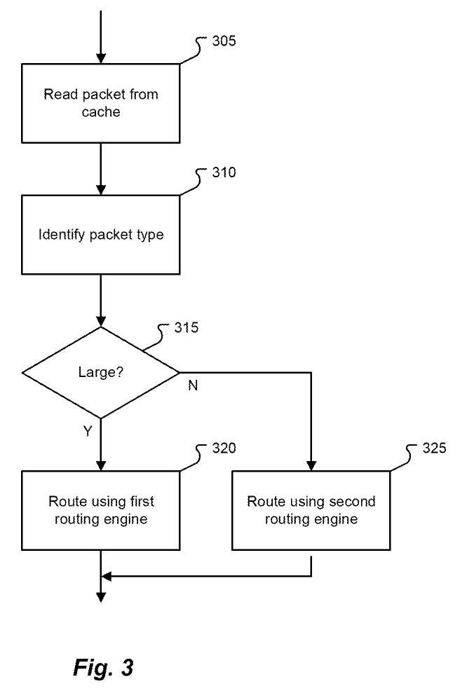

FIG. 3 is a flowchart illustrating an exemplary process for routing packets according to one embodiment of the present disclosure. As illustrated in this example, routing packets in a communication device 115 can comprise reading 305 a packet received from a communication network and identifying 310 a packet type for the packet. In this example, the packet type may be based on a size of the packet and a predefined packet length delineating large packets from small packets. The length of the packet can be determined based on a length indicated in a header of the packet, by a counter counting the number of bits entering the switch, and/or in other ways.

A determination 315 can then be made based on the packet type, e.g., whether the packet is a small or large packet. In response to determining 315 the identified packet type is a first packet type, e.g., a large packet, the packet can be provided 320 to the first set of one or more routing engine 120, e.g., the adaptive routing engines. In response to determining 315 the identified packet type is a second packet type, e.g., a small packet, the packet can be provided 325 to the second set of one or more routing engines 125 of the communication switch, e.g., the random or other routing engines.

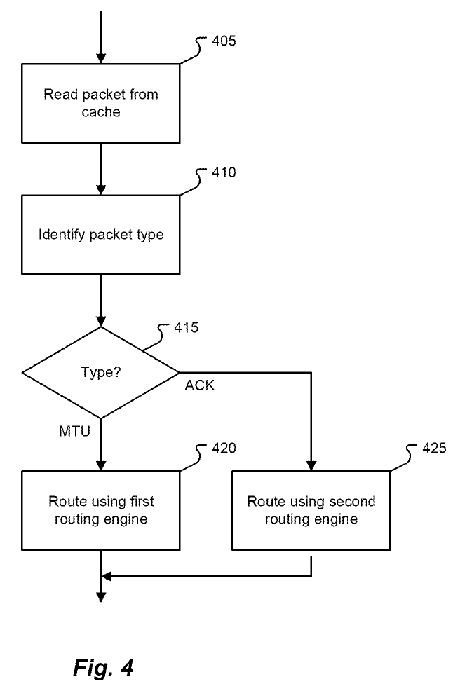

FIG. 4 is a flowchart illustrating an exemplary process for routing packets according to another embodiment of the present disclosure. As illustrated in this example, routing packets in a communication device 115 can comprise reading 405 a packet received from a communication network and identifying 410 a packet type for the packet. A determination 415 can then be made based on the packet type, e.g., whether the packet is an MTU packet or and ACK packet. In response to determining 415 the identified packet type is a first packet type, e.g., an MTU packet, the packet can be provided 420 to the first set of one or more routing engine 120, e.g., the adaptive routing engines. In response to determining 415 the identified packet type is a second packet type, e.g., an ACK packet, the packet can be provided 425 to the second set of one or more routing engines 125 of the communication switch, e.g., the random or other routing engines.

The present disclosure, in various aspects, embodiments, and/or configurations, includes components, methods, processes, systems, and/or apparatus substantially as depicted and described herein, including various aspects, embodiments, configurations embodiments, sub-combinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A communication device comprising:
a communication interface;
a cache coupled with the communication interface;
a first routing engine coupled with the cache;
a second routing engine coupled with the cache, wherein the first routing engine and the second routing engine perform routing of packets from the cache through the communication interface using different types of routing; a control circuit controlling operation of the communication switch, wherein the control circuit causes the communication device to:
read a packet from the cache;
identify a packet type for the packet;
in response to the identified packet type being a first packet type, providing the packet to the first routing engine; and
in response to the identified packet type being a second packet type, providing the packet to the second routing engine.

2. The communication device of claim 1, wherein identifying the packet type for the packet is based on header information for the packet.

3. The communication device of claim 1, wherein identifying the packet type for the packet is based on a predefined packet length.

4. The communication device of claim 1, wherein identifying the packet type for the packet is based on an opcode for the packet.

5. The communication device of claim 4, wherein the first packet type is identified in response to the packet being a Maximum Transmission Unit (MTU) packet.

6. The communication device of claim 5, wherein the second packet type is identified in response to the packet being an ACKnowledgement (ACK) packet.

7. The communication device of claim 1, wherein the first routing engine comprises an adaptive routing engine.

8. The communication device of claim 7, wherein the second routing engine comprises a random routing engine.

9. The communication device of claim 7, wherein the second routing engine comprises a hash-based routing engine.

10. The communication device of claim 7, wherein the second routing engine comprises a weighted Equal-Cost Multi-Patch routing engine.

11. The communication device of claim 7, wherein the second routing engine comprises a round robin routing engine.

12. A system comprising:
a communication network; and a communication device coupled with the communication network, the communication device comprising:
a communication interface coupled with the communication network;
a cache coupled with the communication interface;
a first routing engine coupled with the cache;
a second routing engine coupled with the cache, wherein the first routing engine and the second routing engine perform routing of packets from the cache through the communication interface using different types of routing;
a control circuit controlling operation of the communication switch, wherein the control circuit causes the communication device to:
read a packet from the cache;
identify a packet type for the packet;
in response to the identified packet type being a first packet type, providing the packet to the first routing engine; and
in response to the identified packet type being a second packet type, providing the packet to the second routing engine.

13. The system of claim 12, wherein identifying the packet type for the packet is based on an opcode in header information for the packet.

14. The system of claim 12, wherein the first packet type is identified in response to the packet being a Maximum Transmission Unit (MTU) packet.

15. The system of claim 12, wherein the second packet type is identified in response to the packet being an ACKnowledgement (ACK) packet.

16. The system of claim 12, wherein the first routing engine comprises an adaptive routing engine.

17. The system of claim 16, wherein the second routing engine comprises a random routing engine.

18. A method for routing packets in a communication switch, the method comprising:
reading, by the communication switch, a packet received from a communication network;
identifying, by the communication switch, a packet type for the packet;
in response to the identified packet type being a first packet type, providing, by the communication switch, the packet to a first routing engine of the communication switch; and
in response to the identified packet type being a second packet type, providing, by the communication switch, the packet to a second routing engine of the communication switch, wherein the first routing engine and the second routing engine perform routing of packets from a cache of the communication device through a communication interface of the communication device using different types of routing.

19. The method of claim 18, wherein the first packet type is identified in response to the packet being a Maximum Transmission Unit (MTU) packet, and wherein the second packet type is identified in response to the packet being an ACKnowledgement (ACK) packet.

20. The method of claim 19, wherein the first routing engine comprises an adaptive routing engine and wherein the second routing engine comprises a random routing engine.
